(19) United States
(12) Patent Application Publication
(10) Pub. No.: US 2006/0219880 A1
(43) Pub. Date: Oct. 5, 2006

(54) Optical sensor for electric machines

(75) Inventors: Matthias Braun, Weichtungen (DE); Rolf Vollmer, Gersfeld (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 10/553,697

(22) PCT Filed: Apr. 7, 2004
(86) PCT No.: PCT/EP04/03738

§ 371 Date: Oct. 17, 2005

(30) Foreign Application Priority Data
Apr. 16, 2003 (DE) 103 17 591.1

(51) Int. Cl. G01D 5/34

(52) U.S. Cl. 250/231.13

(57) ABSTRACT

The invention provides that a ferrofluid seal is used in order to create an effective sealing for optical sensors in speed-controllable electric motors.

The invention relates to an optical sensor for electrical machines having means for sealing between the bearing of the sensor and its coding disk.

Optical sensors are used mainly in variable rotation speed motors, in particular for machine tools, for operation and for position control (Kief; NC/CNC Manual 95/96; Carl Hanser Verlag Munich, Vienna). They achieve high angular accuracy (±40 angular seconds). During operation, these sensors are subject to comparatively high temperatures, rotation speeds and, possibly, mechanical oscillations. As a result of these influencing parameters, lubricant, for example oil in some cases passes during operation of the electrical machines out of the bearing of these sensors to the sensor interior. If this lubricant is deposited in the area of the optical scanning on the coding disk, then this leads to sensor failure after a certain time.

The already known standard sealing measures such as sealed centrifugal bearing disks with a catchment groove cannot, however, reliably prevent the emergence of lubricants, and thus the lubricant being deposited on the optical scanning unit.

Accordingly, the invention is based on the object of providing a seal for optical sensors which avoids the disadvantages mentioned above.

The stated object is achieved by the seal being in the form of a ferrofluid seal.

This reliably prevents contamination of the optical sensor by a lubricant, for example oil from the sensor bearing. The formation of a magnetic field ensures that the ferrofluid, as the sealing liquid, is always located in the sealing gap. This avoids the lubricant in the bearing moving through the sealing gap in particular during operation and being precipitated on the optical scanning unit, thus leading to sensor failure. A permanent magnet ensures the sealing function even during times in which the electric motor is stationary.

The sensors advantageously have bearings without play, which additionally increases the high angular accuracy.

The invention as well as further advantageous refinement of the invention according to the features of the dependent claims will be explained in more detail in the following text with reference to an exemplary embodiment, which is illustrated schematically in the drawing.

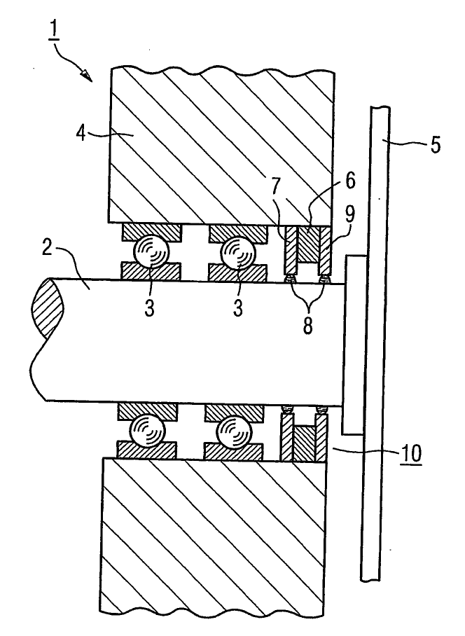

FIG. 1 shows an outline illustration of an optical sensor 1 on whose sensor shaft 2 a coding disk 5 is located, for measurement recording, as part of an optical scanning unit, which is not illustrated in any more detail. The sensor flange 4 is arranged on the sensor shaft 2, via a sensor bearing 3. The sensor bearing 3 is advantageously designed without mirroring, in order to increase the measurement accuracy. A ferrofluid seal 10 is located on the sensor flange 4, between the sensor bearing 3 and the coding disk 5. The ferrofluid seal 10 is formed essentially by a magnet 6 which is magnetized axially with respect to the sensor shaft 2, the flux guide elements 7 and 9 resting on it, and a ferrofluid liquid 8.

The advantageous sealing function is achieved by aligning the ferrofluid liquid 8 between the flux guide elements 7 and 9 and the sensor shaft 2. This alignment is caused by the magnetic field of the magnet 6.

This creates an effective seal, which prevents lubricant, in particular oil, from emerging from the sensor bearing 3 onto the coding disk 5, and leading to sensor failure there.

The use of ferrofluid seals such as this is not, of course, restricted just to sensor arrangements for electrical machines. In fact, they can also be used directly for motors, in particular for motor spindles, where the motor interior must be protected, for example, against liquids, lubricants, dirt or combinations of such contamination of the motor interior, in order to maintain operation of the motor. In this case, the requirement is, for example, to seal the drive motor of tool spindles, in particular against the cooling liquid.

Ferrofluid seals such as these can likewise be used for railroad propulsion systems between a motor and oil-lubricated transmissions.

In this case, all that is necessary is to replace the sensor shaft 2 by a drive shaft, and the sensor flange 4 by a suitable bearing or housing flange.

In this case, a ferrofluid seal 10 is produced by attaching the flux guide elements 7, 9 and the magnet or magnets 6 to a flange, advantageously by adhesive bonding, and then by introducing the ferrofluid liquid 8 into the sealing gap.

1. An optical sensor for an electrical machine, comprising:
a bearing;
a coding disk; and
sealing means for providing a seal between the bearing and the coding disk, said sealing means being constructed in the form of a ferrofluid seal.

2. The optical sensor as claimed in claim 1, wherein the bearing is constructed to support the sensor without play.

3. The optical sensor as claimed in claim 1, further comprising a sensor shaft, and a sensor flange supported by the sensor shaft via the bearing, wherein the ferrofluid seal includes a magnet which is magnetized axially and has opposite end faces, flux guide elements disposed at the end faces, and a ferrofluid liquid, for producing a seal between the sensor flange and the sensor shaft.

4. An optical sensor for an electrical machine, comprising:
a sensor shaft defining an axis;
a bearing for support of the sensor shaft;
a coding disk disposed on the sensor shaft at a distance to the bearing; and
a ferrofluid seal disposed between the bearing and the coding disk to prevent lubricant from migrating from the bearing toward the coding disk.

5. The optical sensor as claimed in claim 4 wherein the bearing is constructed to support the sensor shaft without play.

6. The optical sensor as claimed in claim 4, wherein the ferrofluid seal includes a magnet which is magnetized in axial direction, a flux guide element disposed at one end face of the magnet, and a ferrofluid ring disposed between the flux guide element and an outer surface of the sensor shaft.

7. The optical sensor as claimed in claim 4, wherein the ferrofluid seal includes a magnet which is magnetized in axial direction and has opposite end faces, two flux guide elements disposed respectively at the end faces of the magnet, and two ferrofluid rings disposed respectively between the flux guide elements and an outer surface of the sensor shaft.

8. A ferrofluid seal for use as protection of an operating member against ingress of any contaminant.
